(19) United States
(12) Patent Application Publication
(10) Pub. No.: US 2006/0163540 A1
(43) Pub. Date: Jul. 27, 2006

(54) Solid status electro-chromic device process using conductive polymer nano material

(76) Inventors: Chien-Hsin Yang, Yung Kang City (TW); Yi-Kai Chih, Yung Kang City (TW); Cheng-Ho Chen, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/043,138

(22) Filed: Jan. 27, 2005

(51) Int. Cl. H01B 1/12

(52) U.S. Cl. 252/500

(57) ABSTRACT

A process to manufacture conductive polymer nano material and another process to manufacture all solid status electro-chromic device using the conductive polymer nano material by having soluble ortho-aniline sulfonic acid (meta-aniline sulfonic acid, or 2,5-amiobenzen sulfonic acid) to dissolve in water, added with proper amount of aniline and mixed to be kept at proper temperature for the working temperature to reach equilibrium status; then added into solution of ammonium persulfate (APS) initiator to conduct self-assembly polymerization for availing the conductive polymer nano material, which being further used in the manufacturing of all solid status electro-chromic device.

### BACKGROUND OF THE INVENTION

(a) Field of the Invention

The present invention relates to a manufacturing process of conductive polymer nano material and another manufacturing process of an all solid status electro-chromic device using the conductive polymer nano material, and more particularly to a process to manufacture conductive polymer nano material by using the self-assembly polymerization method in an aqueous solution environment, and further the resultant conductive polymer nano material is used to manufacture the all solid status electro-chromic device.

(b) Description of the Prior Art

Electro-chromic phenomenon refers to the presentation of different color by an electro-chromic substance changing its absorption capacity of the light when subject to externally applied electric filed. Before being driven by the externally applied electric field, those electro-chromic substances admixed with conductive polyaniline nano material is at their discoloration status due to extremely low absorption of the spectrum within the range of visible light; and after the voltage is applied, they are in the status of coloring status to cause change in color. The application of continuous and reversible change of the transmittance ratio or reflection ratio of the electro-chromic color-changing film system by using externally applied voltage or by changing the current direction is comparatively popular. For instance, the electro-chromic window by adjusting the transmission of sunlight into a room; the ceiling window of a car; a color-changing sunglass; the windshield of the flight deck of an airplane; photo-valve, etc.

Conductive polymer has been considered a substitute of the conductive capacity of metal material. In the development and application of the high conductivity, the conductivity of a metal has been not replaceable; however, metal material has its flaw of poor workability or getting too heavy and the similar flaw remains even found with the later developed conductive ceramic material.

In macromolecular chemistry, polyaniline can be polymerized to yield high conductivity by controlling the synthesis steps, and the control has been deemed as a development orientation in hot pursuit during recent years. Patents granted to invention of polyaniline nanotube are quite rare. For example, ZL9810901165 of Chinese Patent is one of the few. In the study of polyaniline nanotube, the aniline is dissolved in external dopant (acid) and all related studies have the acid as the 15 surfactant and the reaction systems are all performed in the proton acid as disclosed in the Chinese Patent No. ZL9810901165. Furthermore, a metal template with multiple nano holes is used to grow the conductive high polymer nanorod. However, the process is found very complicated and prevents mass production of nano materials since strong acid or alkali must be used to dissolve the metal template.

The practical application of the polyaniline is getting more and more popular, and more attention is paid to the application of the high polymer LED and the electro-chromic device. Particularly, having the sulfonated polyaniline to function as the electric hole transport film in the high polymer LED helps promote the light emitting efficiency and luminance of the LED. Generally, the sulfonated polyaniline is synthesis reaction between the fuming sulfuric acid and the polyaniline, and then added with acetone to precipitate the product. However, this sulfonation process is very difficult to control.

### SUMMARY OF THE INVENTION

The primary purpose of the present invention is to provide a process to manufacture conductive polymer nano material in the following steps:
a. Preparation of aqueous solution of ortho-aniline sulfonic acid and aniline: add both of ortho-aniline sulfonic acid and aniline into distilled water, well mixed until both are dissolved in the water, and then left in the environment at a temperature lower than 50° C.
b. Preparation of aqueous solution of ammonium persulfate: have the APS dissolved in the distilled water and left in the environment at a temperature lower than 50° C.
c. Self-assembly polymerization reaction: add the aqueous solution prepared in Step b into that prepared in Step a for both solution to undergo a self-assembly polymerization reaction, and then left in the environment at a temperature lower than 50° C.
d. Completion: the substance formed in Step c is the resultant material.

The present invention also relates to a process to manufacture the all solid-status electro-chromic device using the conductive polymer nano material availed from Step d in the manufacturing process described above. The manufacturing process of the all solid status electro-chromic device involves the following steps:
a. Developing a film of the conductive polymer nano material on an indium tin oxide (ITO) glass: have the self-doping polyaniline nanotube of the electrode material to develop a film on the indium tin oxide (ITO) glass.
b. Coating a film of counter electrode material on another indium tin oxide (ITO) glass: have another indium tin oxide (ITO) glass coated a film of the counter electrode material using the plating or the dipping method.
c. Preparig the electrolyte.
d. Connecting the electrolyte and both pieces of indium tin oxide (ITO) glass: have the electrolyte sandwiched between both pieces of indium tin oxide (ITO) glass prepared in Steps a and b to connect them to create an electro-chromic device.

The present invention uses the soluble ortho-aniline sulfonic acid (meta-aniline sulfonic acid, or 2,5-amiobenzene sulfonic acid) to dissolve in water, added with proper amount of aniline and mixed to be kept at a temperature lower than 50° C. for the working temperature to reach equilibrium status; then added into solution of ammonium persulfate (APS) initiator to conduct self-assembly polymerization for availing the conductive polymer nano material. This process is different from the prior art wherein the aniline is dissolved in the externally added protonic acid to serve as the surfactant.

The process of the present invention is very simple and allows easy control of the chemical composition of the polymer. Wherein, the ortho-aniline sulfonic acid in the present invention has double roles, respectively, the reactive monomer and the self-doping to serve as the surfactant for the aniline to save the externally added protonic acid as the dopant.

Polyaniline for providing high stability in the environment is one of the comparatively important conductive polymers. It has been proved that polyaniline gives multiple color changing results according to the changed voltage. The process disclosed in the present invention is comparatively simple by allowing easy adjustment of the ratio between the aniline and the ortho-aniline sulfonic acid for the control of the diameter of the final nano material to become a hollow tube type of nano material or a solid rod nano material as applicable while the self-doping polyaniline conductive polymer is used as the material for further manufacturing of electro-chromic material.

### BRIEF DESCRIPTION OF THE DRAWINGS

FIG. 1 is a flow chart of the process of the present invention for the manufacturing of conductive polymer nano material.

FIG. 2 is another flow chart of another process of the present invention for the manufacturing of all solid status electro-chromic device using the conductive polymer nano material.

### DETAILED DESCRIPTION OF THE PREFERRED EMBODIMENTS

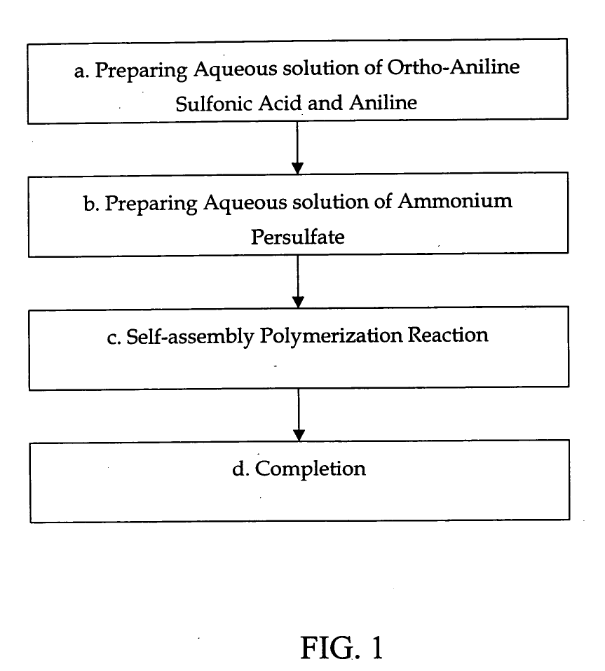

Referring to FIG. 1 for a preferred embodiment of the present invention for a process to manufacture a conductive polyaniline nanotube, the process includes the following steps:
a. Preparing ortho-aniline sulfonic acid and aniline aqueous solution: precision scale for 0.2165˜0.4325 g of the ortho-aniline sulfonic acid and 0.11˜150.23 g of aniline and have both placed in a beaker; add into the beaker of 100 ml distilled water and well mixed for both to dissolve in the water, and then left in an environment at a temperature lower than 50° C., or 5˜25° C. is preferred.
b. Preparing of aqueous solution of ammonium persulfate (APS):

Scale for 0.57˜1.14 g of APS to dissolve in 25 ml of distilled water and left in the environment at a temperature lower than 50° C., or 5˜25° C. is preferred.
c. Self-assembly polymerization reaction: wait for the temperature of the aqueous solution respectively prepared in Steps a and b to become equilibrium status, fetch 12.5 ml of the aqueous solution prepared in Step b to add into that prepared in Step a for both solution to undergo a self-assembly polymerization reaction, and then left in the environment at a temperature lower than 50° C., or 5˜25° C. is preferred.
d. Completion: after a period of time (e.g., 24 hours), the substance formed in Step c is the resultant material.

In the present invention, the ortho-aniline sulfonic acid plays double roles of providing reactive monomer and self-doping without the necessity to external addition of protonic acid to serve as the dopant.

In Step a, the soluble ortho-aniline sulfonic acid may be meta-aniline sulfonic acid, or 2,5-amiobenzene sulfonic acid.

In Step a, the consumption amount respectively of the ortho-aniline sulfonic acid, aniline, and the distilled water may be altered as applicable.

The consumption amount of the persulfate in Step c may also be altered as applicable.

In Step c, AgNO₃ may be introduced to the reaction to have Ag metal nano particles wrapped up in the polymer matrix.

In Step c, FeCl₂ and FeCl₃ may be introduced to the reaction to have Fe₃O₄ metal nano particles wrapped up in the polymer matrix.

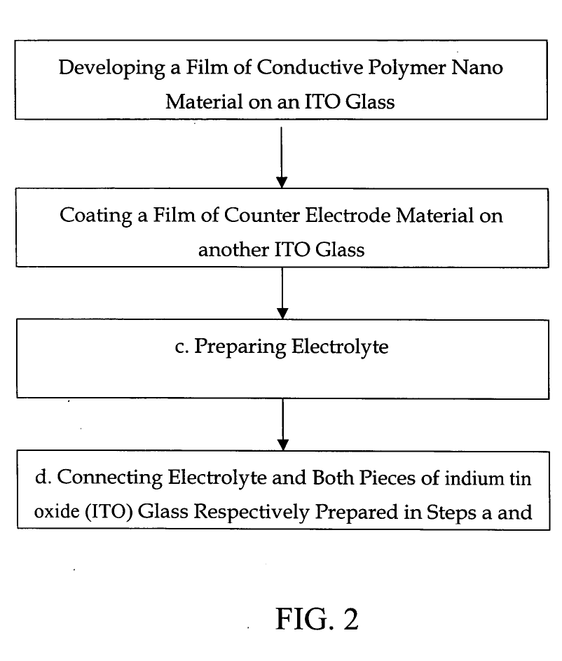

The present invention also relates to another process for the manufacturing of all solid status electro-chromic device using the conductive polymer nano material. As illustrated in FIG. 2, another preferred embodiment of the present invention involves a process of manufacturing an all solid status electro-chromic device using the self-doping polyaniline nanotube. The process involves the following steps:
a. Developing a film of the conductive polymer nano material on an indium tin oxide (ITO) glass: have the self-doping polyaniline nanotube of an electrode material to grow a film on the indium tin oxide (ITO) glass using the suspension method.
b. Coating a film of counter electrode material on another indium tin oxide (ITO) glass: have another indium tin oxide (ITO) glass coated a film of the counter electrode material such as WO₃ or polythiophene using the plating or the dipping method.
c. Preparing the electrolyte.
d. Connecting the electrolyte and both pieces of indium tin oxide (ITO) glass: have the electrolyte sandwiched between both pieces of indium tin oxide (ITO) glass prepared in Steps a and b to connect them to create an electro-chromic device.

Those films of the electro-chromic device formed in those steps described above are in the sequence of indium tin oxide (ITO) glass, self-doping poly aniline nanotube, electrolyte, counter electrode material, and another piece of indium tin oxide (ITO) glass.

In Step b, the WO₃ is prepared by adding 1.4 g of tungsten into 10 ml of 30% hydrogen peroxide, and then diluted to 250 ml.

In Step c, the electrolyte may be related to a gel electrolyte. For example, the gel electrolyte is prepared by scaling for 4 g of polymethyl methacrylate (PMMA), 0.015 g of LiClO₄, and 15 ml of solvent propylene carbonate (PC).

In Step c, the electrolyte may be related to a solid status electrolyte, such as that comprised of polyurethane elastomer and LiClO₄.

What is claimed is:

1. A process to manufacture conductive polymer nano material including the follow steps:
a. preparation of aqueous solution of ortho-aniline sulfonic acid and aniline: add both of ortho-aniline sulfonic acid and aniline into distilled water, well mixed until both are dissolved in the water, and then left in the environment at a temperature lower than 50° C.;
b. preparation of aqueous solution of ammonium persulfate (APS): have the APS dissolved in the distilled water and left in the environment at a temperature lower than 50° C.;
c. self-assembly polymerization reaction: add the aqueous solution prepared in Step b into that prepared in Step a for both solution to undergo a self-assembly polymerization reaction, and then left in the environment at a temperature lower than 50° C., and
d. completion: the substance formed in Step c is the resultant material.

2. The process to manufacture conductive polymer nano material of claim 1, wherein the ortho-aniline sulfonic acid is replaced with meta-aniline sulfonic acid.

3. The process to manufacture conductive polymer nano material of claim 1, wherein the ortho-aniline sulfonic acid is replaced with 2,5-amiobenzen sulfonic acid.

4. The process to manufacture conductive polymer nano material of claim 1, wherein, AgNO₃ is introduced to the reaction to have Ag metal nano particles wrapped up in the solution in Step C.

5. The process to manufacture conductive polymer nano material of claim 1, wherein FeCl₂ and FeCl₃ are introduced to the reaction to have Fe₃O₄ metal nano particles wrapped up in the solution in Step c.

6. The process to manufacture conductive polymer nano material of claim 1, wherein the incubation time for Step c is 24 hours.

7. A process to manufacture all solid-status electro-chromic device using conductive polymer nano material including the following steps:
a. developing a film of the conductive polymer nano material on an indium tin oxide (ITO) glass: have the self-doping polyaniline nanotube of the electrode material to develop a film on the indium tin oxide (ITO) glass;
b. coating a film of counter electrode material on another indium tin oxide (ITO) glass: have another indium tin oxide (ITO) glass coated a film of the counter electrode material using the plating or the dipping method;
c. preparing the electrolyte, and
d. connecting the electrolyte and both pieces of indium tin oxide (ITO) glass: have the electrolyte sandwiched between both pieces of indium tin oxide (ITO) glass prepared in Steps a and b to connect them to create an electro-chromic device.

8. The process to manufacture all solid-status electro-chromic device using the conductive polymer nano material of claim 7, wherein the counter electrode material is WO₃.

9. The process to manufacture all solid-status electro-chromic device using the conductive polymer nano material of claim 7, s wherein the counter electrode material used in Step b is WO₃.

10. The process to manufacture all solid-status electro-chromic device using the conductive polymer nano material of claim 7, wherein the counter electrode material used in Step b is polythiophene.

11. The process to manufacture all solid-status electro-chromic device using the conductive polymer nano material of claim 9, wherein the WO₃ is prepared by adding 1.4 g of tungsten added into 10 ml of 30% hydrogen peroxide, and then diluted to 250 ml.

12. The process to manufacture all solid-status electro-chromic device using the conductive polymer nano material of claim 7, wherein the electrolyte used in Step c is a gel electrolyte.

13. The process to manufacture all solid-status electro-chromic device using the conductive polymer nano material of claim 12, wherein the gel electrolyte is prepared by scaling for 4 g of polymethyl methacrylate (PMMA), 0.015 g of LiClO₄, and 15 ml of solvent propylene carbonate (PC) in Step c.

14. The process to manufacture all solid-status electro-chromic device using the conductive polymer nano material of claim 7, wherein, the electrolyte is a solid status electrolyte, such as that comprised of polyurethane elastomer and LiClO₄ in Step c.
